(19) United States
(12) Patent Application Publication
(10) Pub. No.: US 2003/0169777 A1
(43) Pub. Date: Sep. 11, 2003

(54) Data reception and playback method, data receiving and playback apparatus, and data communication apparatus

(76) Inventor: Hidetoshi Fuse, Yokohama-shi (JP)

Correspondence Address: STEVENS, DAVIS, MILLER & MOSHER, L.L.P., Suite 850, 1615 L Street, N.W., Washington, DC, 20036, US

(21) Appl. No.: 10/377,887

(22) Filed: Mar. 4, 2003

(30) Foreign Application Priority Data
Mar. 5, 2002 (JP) 2002-058530

(51) Int. Cl. H04J 3/06

(52) U.S. Cl. 370/516

(57) ABSTRACT

When packets that are received via a network susceptible to delay variations and data loss are restored into sound and image for a playback where a transmitting apparatus and a receiving apparatus are not synchronized, a data reception and playback method is provided to secure a stable continuous playback by preventing overflow and underflow in a buffer of the receiving apparatus. By the above method, delay variations are calculated variation time calculator 110 in relative to the reference packet based on the information on the time stamps included in the received packets to denote the reception time. Then by smoothing the calculated signals in smoother 111, and then by monitoring, in smooth output monitor 112, difference between the system clock of a transmitting apparatus and the system clock of a receiving apparatus based on the smoothed output signals, and based on this system clock difference the output frequency of voltage control oscillator 113 and the counter value on read counter 214 are corrected.

### BACKGROUND OF THE INVENTION

1. Field of the Invention

The present invention relates to methods of data reception and playback, apparatus for data reception and playback, and apparatus for data communication.

2. Description of Related Art

In recent years, techniques for communicating continuous data that is to be played on audio players and video players through a transmission channel of a network and the like have been in use. In data communications that bypasses a transmission channel, a transmitting apparatus is configured separately from a receiving apparatus. Accordingly, a system clock of a transmitting apparatus is separate from a system clock of a receiving apparatus, which makes it extremely difficult to perfectly synchronize these transmitting and receiving apparatus.

When continuous data is transmitted from a transmitting apparatus to be played in real time in a receiving apparatus, even when the receiving apparatus is equipped with a buffer, underflow or overflow of the continuous data occurs in the receiving apparatus due to the aforementioned difficulty of synchronization. As a result, problems arise in the receiving apparatus including the loss of continuity of the received data, breaks in the playback sound, noise in the playback sound, and flows in video images.

Moreover, when the environment for transmission is undesirable, it may be necessary to reset a receiving apparatus to its original state while reception of continuous data is in progress, and this results in a long pause in the playback of continuous data.

In order to prevent such underflow or overflow in a buffer of a receiving apparatus, some techniques have been developed for monitoring the volume of data that is kept in a buffer of a receiving apparatus and for synchronizing the receiving apparatus with a transmitting apparatus. Examples of such techniques are disclosed in Unexamined Japanese Patent Application Publication No.HEI9-252292 and Unexamined Japanese Patent Application Publication No.2000-22678.

In data communications through a transmission channel, in particular with respect to data communication through a packet-based transmission channel such as an IP (Internet Protocol) network, it is necessary to take into account the fact that when a number of packets are to be received in sequence via a transmission channel, the time it takes from a transmitting apparatus to a receiving apparatus varies from one packet to another. Incidentally, when the term “delay variation” is used in the following descriptions of the present invention, it refers to both variations in delay time on a per packet basis, and differences between the delay time of a packet of reference and the delay times of other non-reference packets.

The technique disclosed in Unexamined Japanese Patent Application Publication No.HEI9-252292 is directed to monitoring increase/decrease in the volume of data that is kept in a buffer provided to absorb differences in the frequency of the oscillation source between the transmitting and receiving apparatus, so as to constantly control the oscillation frequency of a generating source (i.e. the oscillation source of a receiving apparatus) of coding clocks for use to pull data out of receiving buffer output ends. In other words, the above technique focuses only on the difference between the system clocks of a transmitting apparatus and a receiving apparatus, and assumes an ideal transmission environment where there is no delay variation.

Likewise, Unexamined Japanese Patent Application Publication No.2000-22678 discloses techniques in relationship to a data transmission terminal apparatus that comprises a transmission buffer for storing transmission data and a receiving buffer for storing received data, and that transmits prescribed data from the transmission buffer using a transmission clock different than a transmission clock of the receiving end. When prescribed data is transmitted from a transmitting apparatus and stored in a receiving buffer of a receiving apparatus, the volume of variations in the volume of data that is to be stored is detected on a regular basis, and, using statistical methods, adjustment clocks that correspond to the volume of variations are obtained. Using these adjustment clocks, the transmission clock of the receiving end is corrected so as to synchronize the receiving apparatus (i.e. data transmission terminal apparatus) with the system clock of the transmitting end.

The above technique makes it possible to accurately synchronize the system clock of a receiving apparatus to the system clock of a transmitting apparatus, even where there are delay variations between some of a number of packets that are received. Still, if there are random delay variations with respect to virtually all packets, it is difficult to achieve accurate synchronization between the system clock of a receiving apparatus and the system clock of a transmitting apparatus. Moreover, by the above technique, the volume of data that is stored in a receiving buffer fluctuates, when coded data that is output form a coder provided for coding continuous data such as sound and images does not stay at a constant bit rate, or when a packet loss occurs on a transmission channel, which makes it difficult to achieve accurate synchronization between the system clocks of a transmitting apparatus and a receiving apparatus.

### SUMMARY OF THE INVENTION

It is therefore an object of the present invention to provide a data receiving and playback apparatus, a data receiving and playback method, and a data communication apparatus, whereby continuous data can be played in real time without causing underflow or overflow in a buffer in a receiving apparatus, even where continuous data such as sound and images is in constant communication between a transmitting apparatus and a receiving apparatus via a transmission channel that is susceptible to packet loss and delay variations, and where a transmitting apparatus and a receiving apparatus are equipped with respective system clocks that are not synchronized in advance.

According to one aspect of the present invention, a data reception and playback method comprises the steps of: recording a reception time on each of a plurality of packets upon reception in a receiving apparatus, where the plurality of packets are each assigned a time stamp in a transmitting apparatus and transmitted to the receiving apparatus; acquiring information on variation between a system clock of the transmitting apparatus and a system clock of the receiving apparatus based on the time stamp and the reception time; and correcting the system clock of the receiving apparatus in accordance with the information on the variation between the system clocks.

According to another aspect of the present invention, a data reception and playback method comprises the steps of: recording a value on a counter comprised in a receiving apparatus upon reception of each of a plurality of packets, where each packet is assigned a time stamp in a transmitting apparatus and transmitted to the receiving apparatus; acquiring information on difference between a system clock of the transmitting apparatus and the system clock of the receiving apparatus based on the time stamp and the value on the counter; and correcting the value on the counter in accordance with the information on the difference between the system clocks.

According to yet another aspect of the present invention, a data receiving and playing apparatus comprises: a packet disassembler that disassembles a received packet and extracts a time stamp assigned on the packet; a read timing controller tat determines a timing to read out the packet based on the extracted time stamp and the number of cycle times of a system clock; a variation time calculator that calculates a delay time variation between a plurality of packets that are received; a smoother that smoothes the delay time variation between the plurality of packets; and a smooth output monitor that monitors an output signal from the smoother and adjusts the system clock in accordance with the output signal.

According to yet another aspect of the present invention, a data communication apparatus comprises the above data receiving and playing apparatus, and further comprises: a packet assembler that makes coded data into a packet with a time stamp assigned thereon; and a transmission channel interface that transmits the packet to a receiving apparatus connected to a transmission channel.

According to yet another aspect of the present invention, a data receiving and playing apparatus comprises: a packet disassembler that disassembles a received packet to extract a time stamp assigned on the packet; a read timing controller that determines a timing to read out the packet based on the extracted time stamp and a value on a counter comprised in the apparatus; a variation time calculator that calculates a delay time variation between a plurality of packets that are received; a smoother that smoothes the delay time variation between the plurality of packets; and a smooth output monitor that monitors an output signal from the smoother and adjusts the system clock in accordance with the output signal.

According to yet another aspect of the present invention, a data communication apparatus comprising the data receiving and playing apparatus of claim 12, and further comprises: a packet assembler that makes codes data into a packet with a time stamp assigned thereon; and a transmission channel interface that transmits the packet to a receiving apparatus connected to a transmission channel.

### BRIEF DESCRIPTION OF DRAWINGS

The above and other objects and features of the present invention will appear more fully hereinafter from a consideration of the following description taken in connection with the accompanying drawings wherein examples are illustrated, in which:

FIG.1 is a block diagram showing a configuration of data receiver/player according to the first embodiment of the present invention;

FIG.2 is a block diagram showing a configuration of data receiver/player according to the second embodiment of the present invention;

FIG.3 is illustrates the relationship between the timings of packet transmission and packet reception;

FIG.4 shows types of delay variations of packets as observed in receiving apparatus;

FIG.5 illustrates packet delay variations as observed in receiving apparatus;

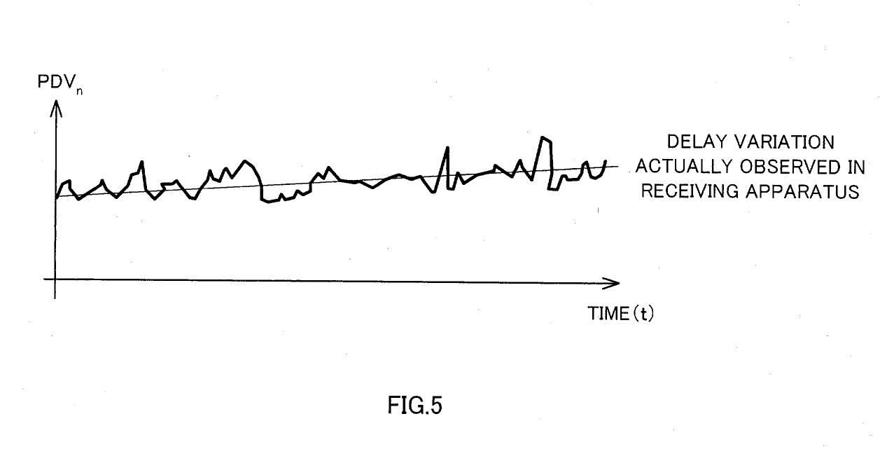

FIG.6 is a block diagram showing a configuration of smoother according to the present invention;

FIG.7 shows an example of output signal from smoother according to the present embodiment;

FIG.8 is a flow chart of the steps of the method as described as the first embodiment of the present invention; and

FIG.9 is a flow chart of the steps of the method as described as the second embodiment of the present invention.

### DESCRIPTION OF PREFERRED EMBODIMENTS

In packet-based data communications where a system clock of a transmitting apparatus is not in synch with a system clock of a receiving apparatus, the invention presented herein is directed to playing data in the receiving apparatus in real time, at a high quality, by synchronizing the receiving apparatus and the transmitting apparatus using the time stamps that are attached on received packets and time information that is recorded on the packets upon reception.

With reference to the accompanying drawings now, preferred embodiments of the present invention will be described below.

(Embodiment 1)

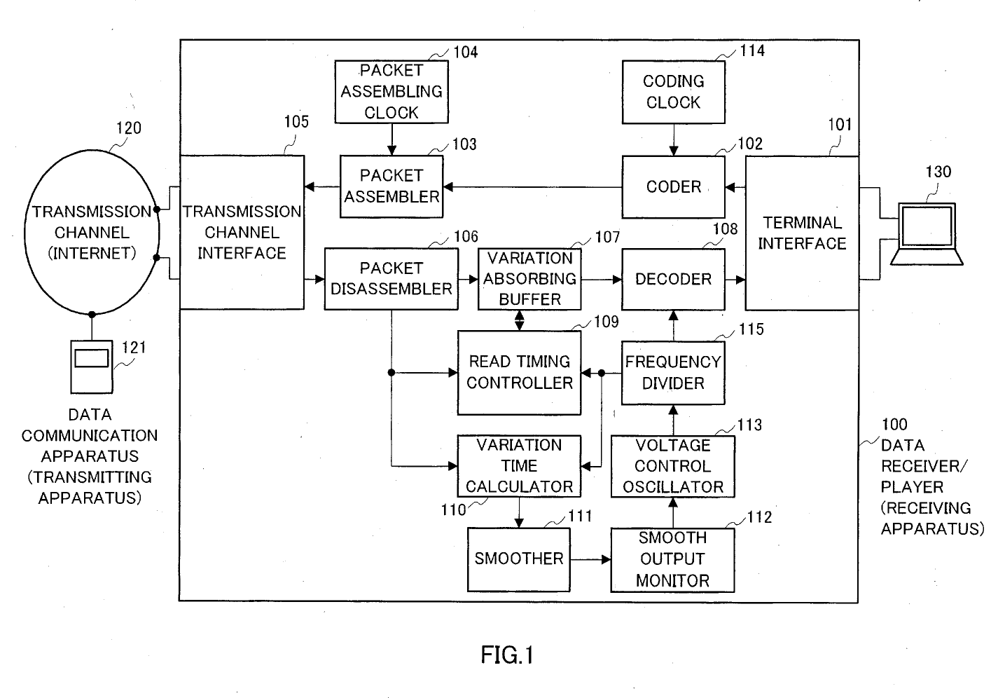

FIG.1 is a block diagram showing a configuration of a data receiver/player (which becomes data communication apparatus if featuring data transmission function) according to the present mode of embodiment.

In FIG.1, data receiver/player (hereinafter often referred to as “receiving apparatus”) 100 comprises means for receiving a number of packets that are transmitted from a communication partner's communication apparatus (hereinafter often referred to as “transmitting apparatus”) and that arrive through transmission channel 120 such as the Internet, for restoring image data or sound data from the packets that are received, and for playing the data by means of connected monitor 130 and the like.

Referring to the reference numerals of FIG. 1, the components of the data receiver/player of the present invention, and their functions, will be described.

Terminal interface 101 is an input/output for connecting a microphone, a speaker, a camera, a monitor and the like to data receiver/player 100 and to communicate sound data or image data there between.

Coder 102 converts the sound data or image data received from terminal interface 101 to digital signals and encodes them.

Packet assembler 103 makes the coded data received from coder 102 into packets with time stamps thereon.

Packet assembling clock 104 communicates the packet assembling times for use in the generation of the above time stamps to packet assembler 103.

Transmission channel interface 105 is connected to packet-based transmission channel 120 such as an IP network, transmits the packets created in packet assembler 103 to transmission channel 120, and outputs the packets transmitted thereto via transmission channel 120 to packet disassembler 106.

Packet disassembler 106 disassembles the packets output from transmission interface 105, and extracts the time stamps and the coded data therefrom.

After the packets are received for a continuous playback of sound data and image data, variation absorbing buffer 107 stores the time stamps and coded data on a temporary basis until the data is actually played, even where the received packets vary in delay time and cause delay variations.

Decoder 108 decodes the coded data output from variation absorbing buffer 107 and outputs it to terminal interface 101.

Read timing controller 109 controls the timing to read out the temporarily stored data in variation absorbing buffer 107 to decoder 108 based on the time stamps temporarily stored in variation absorbing buffer 107 and the reception times calculated from the system clock from voltage control oscillator 113 in frequency divider 115 (the system clock frequency of the receiving apparatus).

Variation time calculator 110 calculates the delay variation for each of a number of packets that are received, based on the time stamp output from packet disassembler 106 and the reception time calculated from the frequency from frequency divider 115.

Smoother 111, when the delay variations calculated in variation time calculator 110 are input, carries out smoothing processing such as LPF (Low Pass Filtering) and the like.

Smooth output monitor 112 monitors output from smoother 111 on a regular basis, and performs frequency control for voltage control oscillator 113 in accordance with the volume of increase and decrease in the volume of smoothed output during the monitoring period.

Voltage control oscillator 113 generates the source cycle of the frequency that was utilized to generate the read timing in read timing controller 109 and the frequency that was utilized in decoder 108.

Coding clock 114 communicates the timing for coding to coder 102.

Frequency divider 115 divides the source cycle from voltage control oscillator 113 and provides the clocks to read timing controller 109 and decoder 108. Incidentally, the frequencies provided from frequency divider 115 to read timing controller 109 and to decoder 108 do not have to be the same.

Next, the operation of data receiver/player 100 will be described.

Data that is coded in coder 102 of a transmitting apparatus is assembled into packets in packet assembler 103, whereupon a time stamp is attached on each packet with coded data.

A time stamp is determined in terms of the timing calculated from packet disassembling clock 104 of the transmitting apparatus, or more specifically, by the timing packet disassembler 103 receives the top of coded data in a packet.

Coding clock 114 and packet disassembling clock 104 can utilize the same frequency obtained from a common source cycle through frequency division.

As for the frequency of packet disassembling clock 104, commonly used is 8 KHz for music and 90 KHz for images such as MPEG.

A number of packets assembled in packet assembler 103 are sent out from transmission channel interface 105 for a receiving apparatus via a transmission channel such as an IP network.

When packets are received via a transmission channel, their delay times often vary on a per packet basis.

A packet received via transmission channel interface 105 is disassembled in packet disassembler 106 in a receiving apparatus, whereupon the time stamp and coded data are extracted. The extracted time stamp and coded data are temporarily stored in variation absorbing buffer 107 (the reception recording step).

Upon reception of the initial packet of a call, read timing controller 109 makes a copy of the value obtained by subtracting a variation-absorbing time prescribed in the receiving apparatus from the time stamp. As for the identification of the first packet of a call, a packet is identified when the variation absorbing buffer is empty and receives a packet.

Next, assuming that the first packet of a call is designated as a reference packet, a method of solving delay variations between a plurality of packets received in receiving apparatus 100 will be described (including the step of acquiring information on variations and the step of correction).

Read timing controller 109 sets the initial value by subtracting a variation-absorbing time from the time stamp of the first packet of a call, and, utilizing the frequency obtained by dividing the source cycle of voltage control oscillator 113 in frequency divider 115 (the same frequency as the packet disassembling clock, synchronized with the system clock of the transmitting apparatus by way of the step of acquiring information on variations and the step of correction, which will be described later), counts up the number of cycle times of the frequency in the course of time.

When this count-up value matches with the time stamp of the initial packet of a call, the coded data of the initial packet is output from variation absorbing buffer 107 to decoder 108. As for those other packets received after reception of the initial packet, if the time stamps assigned on these packets match with their respective count-up values, the coded data in these packets are output from variation absorbing buffer 107 to coder 108.

By carrying out this method continuously, each packet that is received solves its delay variation before being output to decoder 18.

Next, the “variation information acquiring step” wherein information on variations between the system clocks of a transmitting apparatus and a receiving apparatus is obtained will be described in detail.

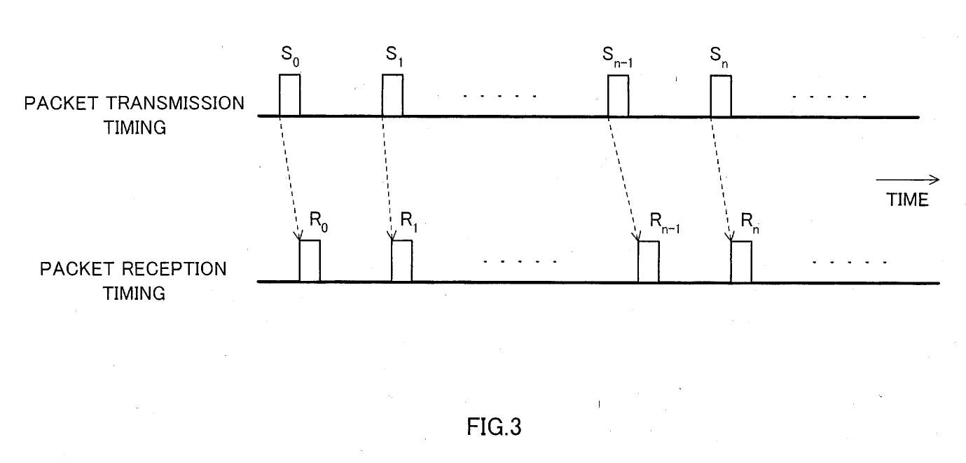

Variation time calculator 110 calculates delay variations between packets received after the reference packet is received. FIG. 3 shows a conceptual diagram showing the timings as to the transmission and reception of the reference packet and other packets.

In FIG. 3, S₀, S₁, . . ., Sₙ₋₁, Sn denote the times when packets are assembled. That is, they denote the time stamp (S₀) assigned on the reference packet (S₀) and the time stamps assigned on other packets (S₁, . . . , Sₙ₋₁, Sₙ). Moreover, R₀, R₁, . . . , Rₙ₋₁, Rₙ denote the reception time of the reference packet (R₀) that is recorded based on the number of cycle times of the clock provided from frequency divider 115 of the receiving apparatus to timing controller 109, and the reception times of other packets (R₁, . . . , Rₙ₋₁, Rₙ).

Using these values, delay variations (PDVₙ) in packets can be obtained by the following equation:

PDVₙ=(Sₙ−S₀)−(Rₙ−R₀)

That is,

Delay variation of a packet=(a packet's time stamp−the reference packet's time stamp)−(a packet's reception time−the reference packet's reception time)

Here PDVₙ refers to both delay variations that occur due to a transmission channel and delay variations that occur due to difference between the system clocks of a transmitting apparatus and a receiving apparatus.

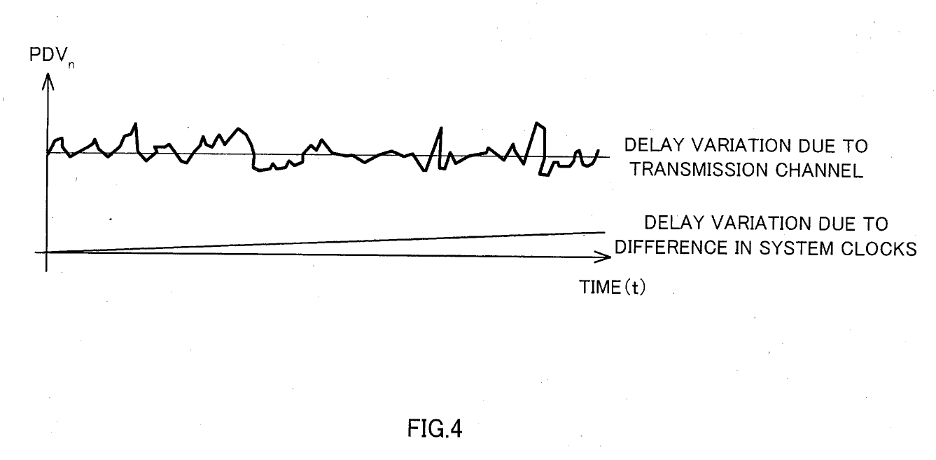

FIG. 4 is a conceptual diagram that separately shows the delay variations caused by transmission channels and the delay variations due to difference between the system clocks of a transmitting apparatus and a receiving apparatus.

As shown in FIG. 4, the delay variations that occur due to a transmission channel randomly fluctuate around the average value, while the delay variations due to difference between the system clocks either rise or decline in the course of time.

When the system clock frequency of a receiving apparatus is higher than the system clock frequency of a transmitting apparatus, the delay variations from difference between the system clocks as observed in the receiving apparatus decline steadily in the course of time.

On the other hand, when the system clock frequency of a receiving apparatus is lower than the system clock frequency of a transmitting apparatus, the delay variations due to difference between the system clocks as observed in a receiving apparatus rise steadily in the course of time.

Then PDVₙ that is actually observed in a receiving apparatus in relationship to several packets that are received is the sum of the delay variations that occur due to a transmission channel and the delay variations due to difference between the system clocks.

Thus, when the difference between system clocks result in variations in delay, the absolute value continues to increase in the course of time, which then, if left uncorrected, results in overflow or underflow of coded data in variation absorbing buffer 107 of a receiving apparatus.

It is therefore necessary to accurately detect differences in system clocks, and synchronize the system clocks of a receiving apparatus and a transmitting apparatus.

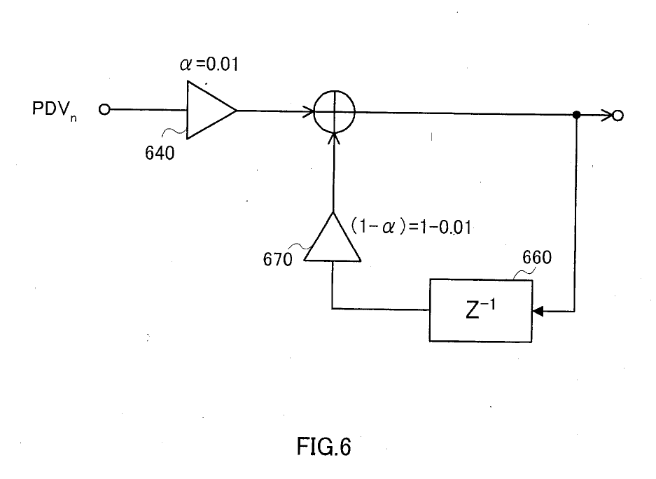

One method thereof is to input PDVₙ into smoother 111 such as shown in FIG. 6 (which comprises buffers 640 and 670, and delayer 660).

This method makes it possible to remove the delay variations caused by transmission channels from PDVₙ that is actually observed in a receiving apparatus, and extract only the delay variations that occur due to difference in system clocks.

Next, the correction step will be described, wherein the delay variations that occur due to difference in system clocks and that are detected in the above variation information acquiring step are solved.

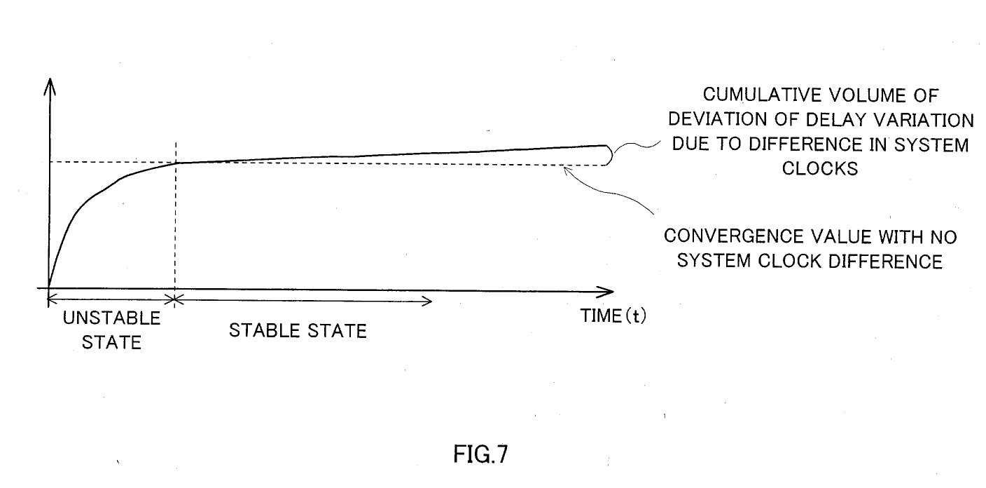

FIG. 7 shows an example of output signal, where PDVₙ is input into smoother 111. Smoother 111 does not follow the delay variations that occur due to a transmission channel that changes relatively rapidly but follows the delay variations that occur due to difference in system clocks and that change relatively moderately, at the tracking speed determined by coefficient a (the coefficient of buffer 640 in FIG. 6). Incidentally, smother 111 does not necessarily require the configuration shown in FIG. 6 and can be a low pass filter (LPF) that let only extremely low frequency that is close to direct current direct pass.

Delay variations due to a transmission channel are random on a per packet basis. On the other hand, the delay variations that occur due to difference in system clocks are cumulative in time and has the characteristic that, when there is no difference between system clocks, the deviation from the conversion value either rises or declines in volume in the course of time.

Given the above noted feature, it is possible to remove the delay variations that occur due to a transmission channel by inputting and smoothing other packets' delay variations in a low pass filter with adequately set time constants, and extract only the delay variations that occur due to difference in system clocks.

When the extracted delay variations exceed a given threshold in the cumulative volume of deviation, the likelihood is high that overflow occurs in a buffer of a receiving apparatus. In such case, the frequency of the system clock in the receiving apparatus needs to be adjusted to accord with the cumulative volume of deviation.

Smooth output monitor 112 monitors output signals from smoother 111 on a regular basis. If changes in output signals during one monitoring period exceed a prescribed threshold, smooth output monitor 112 determines that output signals from smoother 111 are in an unstable state, in which case smooth output monitor 112 performs no control over voltage control oscillator 113.

Smooth output monitor 112 keeps the output from smoother 111 immediately following the determination that output signals have shifted into a steady state, as the initial value.

After output signals from smoother 111 shift into a steady state, smooth output monitor 112 continues monitoring output signals on a regular basis, and, when the difference relative to the initial value that is kept exceeds a prescribed threshold (which is not the threshold value for determination of unstability), a control signal is output from voltage control oscillator 113 for frequency adjustment.

When output signals from smoother 111 grow bigger relative to the initial value in the course of time, smooth output monitor 112 adjusts the frequency of voltage control oscillator a little lower. On the other hand, when the output signals become smaller in the course of time, voltage control oscillator is adjusted such that the frequency thereof becomes a little higher.

The waveform of output signal from smoother 111 assumes an output signal that is input into an ideal LPF.

In actuality, since the delay variations from a transmission channel can have an impact upon the delay variations that occur due to difference in system clocks depending on the value of the α parameter shown in FIG. 6, the above waveform also changes according to the degree of impact.

However, by setting the threshold (the threshold to determine whether control signals be output to voltage control oscillator 113) of smooth output monitor 112 above the maximum level of the delay variations due to a transmission channel, it is possible to disregard the impact of the delay variations due to a transmission channel and extract only the delay variations due to difference in system clocks.

The present embodiment can be summarized as follows: the data reception and playback method of the present embodiment comprises the steps of calculating delay variations and adjusting the system clock frequency. In the former step, a receiving apparatus receives a number of packets transmitted thereto via a transmission channel, and, using the time stamps assigned on the packets, adjusts the timing to play the data restored from the packets, and the packets' delay variations are calculated in relative to the reference packet. In the latter step, the delay variations calculated above are smoothed and smooth output signals are monitored in terms of their increase and decrease in the course of time, by way of which information on difference between the system clocks of a transmitting apparatus and a receiving apparatus are obtained. Based on this information, the system clock of receiving apparatus is increased/decreased so as not to increase the difference between the system clocks of transmitting apparatus and receiving apparatus.

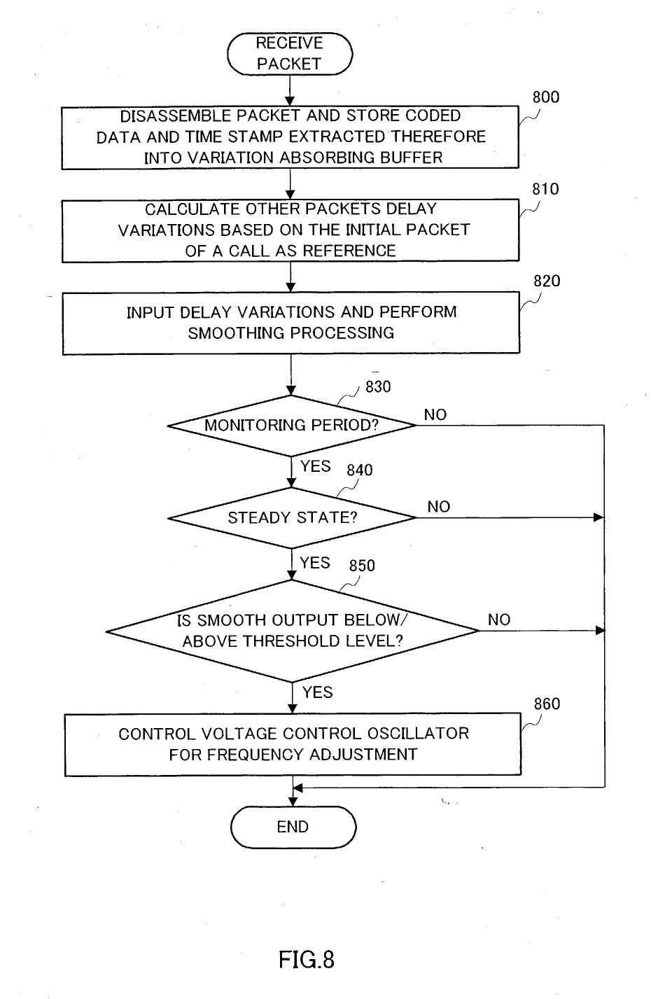

FIG. 8 shows a flowchart showing the way to carry out the steps of the data reception and playback method of the present embodiment.

First, a packet that is received is disassembled, and the coded data and time stamp extracted therefrom are stored in a variation absorbing buffer (Step 800).

Next, the initial packet of a call is designated as the reference packet, and by repeating the variation information acquiring step for each of packets received after reception of the reference packet, their delay variations are calculated based on the difference between the time stamps extracted therefrom and their recorded reception times, and the time stamp and reception time of the reference packet (Step 810).

Then, when the delay variations calculated for each of the non-reference packets, smoothed output signals are obtained (Step 820).

Incidentally, the reference packet does not always have to be the initial packet of a call, and any of the above non-reference packets can be selected as the reference packet.

Following this, determinations are made as to: (1) whether it is the monitoring period to monitor smoothed output signals (Step 830); (2) whether smoothed output signals have shifted form an unstable state to a steady state (Step 840); and (3) whether smoothed output signals have exceeded or are below a threshold (Step 850). If all of the above give a positive answer, the frequency oscillated in voltage control oscillator 113 needs adjustment (Step 860).

By repeating the method including the above-described reception recording step, variation information acquiring step, and the correction step, it is possible to synchronize the system clock of receiving apparatus (data receiver/player) 100 with the system clock of transmitting apparatus 121.

When the system clock of a receiving apparatus is corrected, this changes the frequency utilized in decoder 108, and, to be more particular, changes the pitch of the playback sound as well. However, by adequately setting the period for correcting the frequency of voltage control oscillator 113 or the degree to which such correction is carried out at a time, the above demerits resulting from system clock correction can be minimized to negligible levels.

Therefore, according to the present embodiment, it is possible to prevent the delay variations that occur due to difference in system clocks from accumulating, even where packet-based data communication is performed through a transmission channel susceptible to delay variations and packet loss. As a result, it is possible to play sound or image in real time without causing underflow or overflow in a receiving apparatus.

Moreover, compared to conventional methods whereby the system clock of receiving apparatus is controlled indirectly to accord with capacity in receiving buffer, the present embodiment improves the accuracy of synchronization with transmitting apparatus, thereby making real-time transmission possible virtually regardless of the communication environment.

Furthermore, the present invention allows various changes and modifications.

For instance, such configuration is also possible where the delay variations calculated in respect to a number of packets in variation time calculator 110 are monitored individually and statistically, and, in smoother 111 that is capable of adjusting the cycle of the output signals of smoothed delay variations, the parameters used in smoother 111 can be changed dynamically in accordance with the maximum delay variation level.

To be more specific, when smoother 111 has the configuration of FIG. 6 and the delay variations are relatively small, the convergence time that smoothed output signal takes to reach a steady state can be shortened by raising the a parameter value. In such case, the accumulation of delay variations can be detected at an earlier stage, thereby effectively preventing the delay variations that result from difference in system clocks from accumulating.

On the other hand, when smoother 111 has the configuration of FIG. 6 and the delay variations are relatively large, by reducing the a parameter value, the width of fluctuation can be made smaller compared to the delay variations that occur due to the transmission channel.

(Embodiment 2)

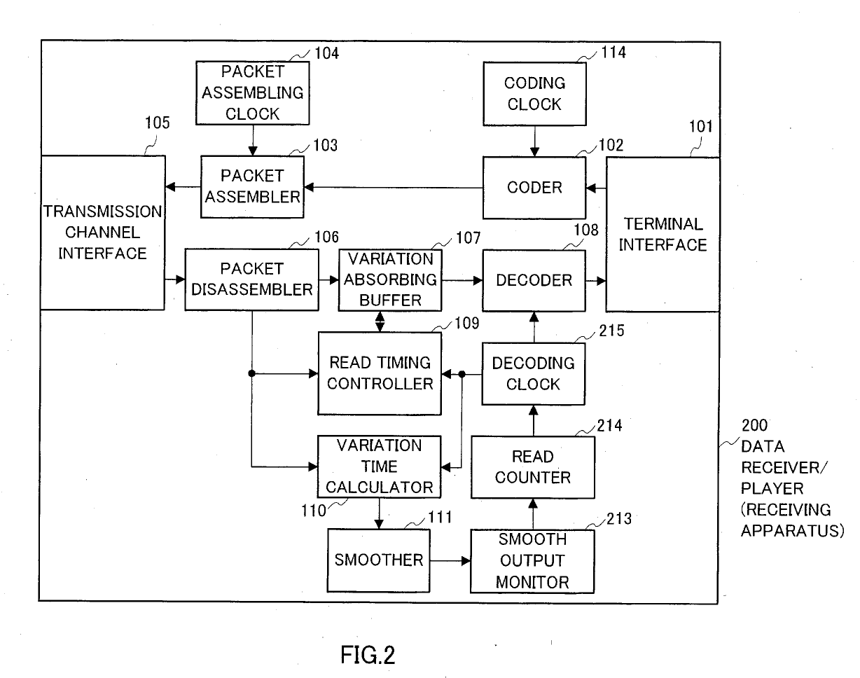

FIG. 2 is a block diagram showing a configuration of another mode of embodiment of the data receiver/player (data transmitter) of the present invention. Parts in the present embodiment identical to those of the above first embodiment are assigned the same reference numerals without further explanations, and only the parts having different functions than those of the first embodiment will be explained.

In FIG. 2, read timing controller 109 controls the timing to read out coded data that is stored in variation absorbing buffer 107 based on the time stamp that is temporarily stored in variation absorbing buffer 107 and the counter value on read counter 214.

Based on the time stamps output from packet disassembler 106 and the counter values on read counter 214, variation time calculator 211 calculates delay variations for each of a number of other packets.

Smooth output monitor 213 regularly monitors output of smoother 111 and raises or reduces the counter value on read counter 214 in accordance with the volume of increase or decrease in output signal from smoother 111.

Read counter 214 outputs the counter value to read timing controller 109 and variation time calculator 110.

Decoding clock 215 supplies clocks for decoding to decoder 108.

Read timing controller 109 sets the value obtained by subtracting variation absorbing time prescribed in data receiver/player 200 from a time stamp extracted in packet disassembler 106.

Read counter 214 sets the initial timing by subtracting the variation absorbing time form the time stamp of the initial packet of a call, and counts up the number of cycle times at the same rate as the frequency of packet assembling clock 104 (the same frequency as the system clock of a receiving apparatus and different from the system clock of a transmitting apparatus).

When this count-up value matches with a time stamp stored in variation absorbing buffer 107, the coded data whereon the time stamp is assigned is read out to coder 108.

Since read counter 214 uses the same frequency with the system clock of the receiving apparatus, so the count-up cycle differs from the cycle of the system clock of the transmitting apparatus. So, the cycle of count-up has an inherent problem that is related to the delay variations due to difference between system clocks. That is, unless the count-up cycle is adjusted in such a way that solves the delay variations that result from difference between system clocks, the delay variations resulting from system clock difference accumulate and cause overflow or underflow of coded data in a buffer of the receiving apparatus.

So, before the delay variations that result from difference between system clocks accumulate and cause overflow and such, these delay variations are extracted through the “variation information acquiring step” which will be described below.

Variation time calculator 110 utilizes the counter values upon reception of respective packets measured in read time counter 214 (R₀′,R₁′, . . . , Rₙ₋₁′, Rₙ′) instead of the reception time of the reference packet (R₀) and the reception times of other non-reference packets (R₁, . . ., Rₙ₋₁,Rₙ). Using these counter values, the following equation still gives other packets' delay variations:

PDVₙ=(Sₙ−S₀)−(Rₙ′−R₀40 )

Smooth output monitor 213 keeps the output signal immediately following the determination that output signals from smoother 111 have shifted into a steady state, as the initial value.

Smooth output monitor monitors output signals of smoother 111 on a regular basis, and when the difference of a smoothed output signal relative to the initial value exceeds a prescribed threshold (i.e. deviation from the threshold value for determining an unstable state), the counter value on read counter 214 is raised/reduced.

When smoothed output signals grow large respective to the initial value kept in smooth output monitor 213, the counter value on read counter 214 is reduced by m.

On the other hand, when smoothed output signals become small, the counter value on read counter 214 is incremented by m.

As for the value of adjustment “m” on read counter 214, it is also possible to prescribe several values in advance in data receiver-player 200 and select an adequate one therefrom according to the volume of increase/decrease (i.e. the deviation volume shown in FIG. 7) of smooth output signals for each given time unit. For instance, when smoother 111 has the configuration FIG. 6, it is possible to provide a number of α parameter values and select adequate α values in accordance with the volume of increase/decrease of smooth output signals.

The present embodiment can be summarized as follows: the data reception and playback method of the present embodiment comprises the steps of calculating delay variations and adjusting the system clock frequency. In the former step, a receiving apparatus receives a number of packets transmitted thereto via a transmission channel, and, using the time stamps assigned on the packets, adjusts the timing to play the data restored from the packets, and the packets' delay variations are calculated in relative to the reference packet. In the latter step, the delay variations calculated above are smoothed and smooth output signals are monitored in terms of their increase and decrease in the course of time, by way of which information on difference between the system clocks of a transmitting apparatus and a receiving apparatus are obtained. Based on this information, the counter value of receiving apparatus is increased/decreased so as not to increase the difference between the system clocks of transmitting apparatus and receiving apparatus.

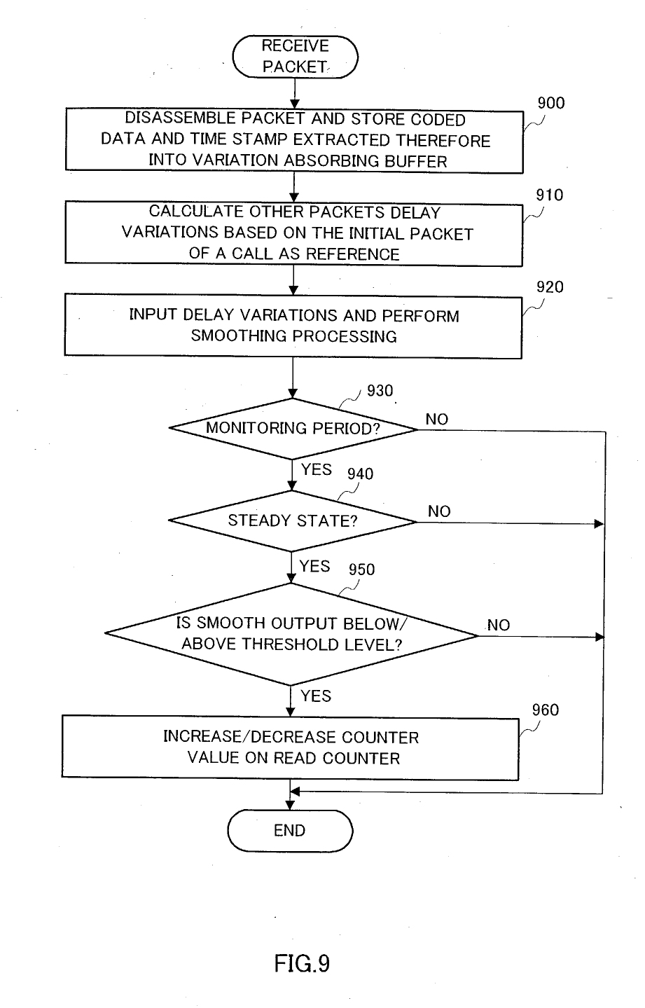

FIG. 9 shows a flowchart showing the way to carry out the steps of the data reception and playback method of the present embodiment.

First, a packet that is received is disassembled, and the coded data and time stamp extracted therefrom are stored in a variation absorbing buffer (Step 900).

Next, the initial packet of a call is designated as the reference packet, and by repeating the variation information acquiring step for each of packets received after reception of the reference packet, their delay variations are calculated based on the difference between the time stamps extracted therefrom and their recorded counter value, and the time stamp and reception time of the reference packet (Step 910).

Then, when the delay variations calculated for each of the non-reference packets, smoothed output signals are obtained (Step 920).

Following this, determinations are made as to: (1) whether it is the monitoring period to monitor smoothed output signals (Step 930); (2) whether smoothed output signals have shifted form an unstable state to a steady state (Step 940); and (3) whether smoothed output signals have exceeded or are below a threshold (Step 950). If all of the above give a positive answer, the counter value on read counter 214 needs adjustment (Step 960).

By repeating the above-described steps, it is possible to synchronize the count-up cycle of read counter 214 in a receiving apparatus and the system clock of a transmitting apparatus on average.

Incidentally, as in Embodiment 1, it is possible to monitor the delay variations calculated in variation calculator 110, and, according to the scale of variation, dynamically change the parameters in smoother 111.

Unlike the first embodiment, the present embodiment does not require voltage control oscillator 113 as an essential part thereof, and can be configured in a more simplified fashion.

Moreover, since there is no need to correct the system clock of a receiving apparatus, data can be played in real time even when the system clock of a transmitting apparatus is inconsistent with the standard time. More notably, the impact of this system clock's inconsistency with the standard time does not extend to other components of the receiving apparatus.

Incidentally, an image coding algorithm such as MPEG 2 provides the method of synchronization between a coder and a decoder. However, this method presumes that there is no delay variation in coded data between a coder and a decoder. When implementing such coding algorithm by means of a data receiver/player, the above embodiments of the present invention are particular suitable, which make separate controls of the frequency for use in a coder and the frequency for use in a decoder are particularly suitable.

The present invention is not limited to the above described modes of embodiment, and various changes and modifications may be possible without departing from the scope of the present invention.

The present application is based on Japanese Patent Application No.2002-58530 filed on Mar. 5, 2002, entire content of which is expressly incorporated herein for reference.

What is claimed is:

1. A data reception and playback method comprising the steps of:
recording a reception, time on each of a plurality of packets upon reception in a receiving apparatus, where said plurality of packets are each assigned a time stamp in a transmitting apparatus and transmitted to said receiving apparatus;
acquiring information on variation between a system clock of said transmitting apparatus and a system clock of said receiving apparatus based on the time stamp and the reception time; and
correcting the system clock of said receiving apparatus in accordance with the information on the variation between the system clocks.

2. The data reception and playback method according to claim 1, wherein the variation information acquiring step further comprises:
selecting a packet that serves as a reference packet from a plurality of packets that are received; and
classifying delay time variations that occur between said plurality of packets into a variation due to a transmission channel and the variation due to difference between the system clocks, and extracting only the delay time variation due to the difference between the system clocks, where the classification is based on the difference between time stamps and reception times of packets different than said reference packet relative to the time stamp and the reception time of said reference packet.

3. The data reception and playback method according to claim 2, wherein the delay time variation due to the difference between the system clocks is extracted by way of smoothing the delay time variations between said packets using a low pass filter.

4. The data reception and playback method according to claim 1, wherein an output cycle for outputting a signal in which the delay time variations between a plurality of packets therein have been smoothed is adjusted, as a parameter that influences said output cycle changes in accordance with said output signal.

5. A data reception and playback method comprising the steps of:
recording a value on a counter comprised in a receiving apparatus upon reception of each of a plurality of packets, where each packet is assigned a time stamp in a transmitting apparatus and transmitted to said receiving apparatus;
acquiring information on difference between a system clock of said transmitting apparatus and the system clock of said receiving apparatus based on the time stamp and the value on said counter; and
correcting the value on said counter in accordance with the information on the difference between the system clocks.

6. The data reception and playback method according to claim 5, wherein the variation information acquiring step further comprises:
selecting a packet that serves as a reference packet from a plurality of packets that are received; and
classifying delay time variations that occur in said plurality of packets into a variation due to a transmission channel and the variation due to difference between the system clocks and extracting only the delay time variation due to the difference between the system clocks, where the classification is based on the difference between time stamps and the value on said counter of packets different than said reference packet relative to the time stamp and the value on said counter of said reference packet.

7. The data reception and playback method according to claim 6, wherein the delay time variation due to the difference between the system clocks is extracted by way of smoothing the delay time variations between said packets using a low pass filter.

8. The data reception and playback method according to claim 5, wherein an output cycle for outputting a signal in which the delay time variations between a plurality of packets therein have been smoothed is adjusted, as a parameter that influences said output cycle changes in accordance with said output signal.

9. A data receiving and playing apparatus comprising:
a packet disassembler that disassembles a received packet and extracts a time stamp assigned on said packet;
a read timing controller that determines a timing to read out said packet based on the extracted time stamp and the number of cycle times of a system clock;
a variation time calculator that calculates a delay time variation between a plurality of packets that are received;
a smoother that smoothes the delay time variation between said plurality of packets; and
a smooth output monitor that monitors an output signal from said smoother and adjusts the system clock in accordance with said output signal.

10. The data receiving and playing apparatus according to claim 9, wherein said smoother further comprises means to adjust an output cycle for outputting a signal in which the delay time variations between a plurality of packets therein have been smoothed, by changing a parameter that influences said output cycle in accordance with said output signal.

11. A data communication apparatus comprising the data receiving and playing apparatus of claim 9, and further comprising:
a packet assembler that makes coded data into a packet with a time stamp assigned thereon; and
a transmission channel interface that transmits said packet to a receiving apparatus connected to a transmission channel.

12. A data receiving and playing apparatus comprising:
a packet disassembler that disassembles a received packet to extract a time stamp assigned on said packet;
a read timing controller that determines a timing to read out said packet based on the extracted time stamp and a value on a counter comprised in the apparatus;
a variation time calculator that calculates a delay time variation between a plurality of packets that are received;
a smoother that smoothes the delay time variation between said plurality of packets; and
a smooth output monitor that monitors an output signal from said smoother and adjusts the system clock in accordance with said output signal.

13. The data receiving and playing apparatus according to claim 12, wherein said smoother further comprises means to adjust an output cycle for outputting a signal in which the delay time variations in a plurality of packets therein have been smoothed, by changing a parameter that influences said output cycle in accordance with said output signal.

14. A data communication apparatus comprising the data receiving and playing apparatus of claim 12, and further comprising:
a packet assembler that makes codes data into a packet with a time stamp assigned thereon; and
a transmission channel interface that transmits said packet to a receiving apparatus connected to a transmission channel.
